(19) United States
(12) Patent Application Publication
(10) Pub. No.: US 2005/0086106 A1
(43) Pub. Date: Apr. 21, 2005

(54) Information recording device, advertisement information management device, information recording method, advertisement information management method, information recording program, advertisement information management program and advertisement information management system

(75) Inventor: Shushi Takiyama, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/796,030

(22) Filed: Mar. 10, 2004

(30) Foreign Application Priority Data
Oct. 21, 2003 (JP) 2003-360908

(51) Int. Cl. G06F 17/60; H04N 7/025; H04N 7/10; H04N 5/781; H04N 5/85; H04N 5/90; H04N 5/91

(52) U.S. Cl. 705/14; 725/32

(57) ABSTRACT

An advertisement insertion server selects advertisement information to be inserted into information and transmits, based on this selection, the advertisement information to be inserted into the information to an advertisement insertion terminal. The advertisement insertion terminal receives the advertisement information to be inserted into the information, inserts the advertisement information into the information and thus records the information. A notification that the advertisement information has been inserted into the information and recorded, is given to the advertisement insertion server to acquire the benefit. The advertisement insertion server receives the thus-given notification for acquiring the benefit and records information about the benefit given to the user on the basis of this notification.

### BACKGROUND OF THE INVENTION

1. Field of the Invention

The invention relates to an information recording device, an advertisement information management device, an information recording method, an advertisement information management method, an information recording program, an advertisement information management program and an advertisement information management system.

2. Description of the Related Art

There has hitherto been a technology by which information such as a TV program, etc. is distributed from an information distributor like, for example, a broadcasting station, etc. In this type of technology, there are a case of distributing the information free of charge and a case of distributing the information with a charge. In the case where the information distributor such as the broadcasting station, etc. distributes the information free of charge, the information distribution party like the broadcasting station, etc. distributes the information in a way that attaches an advertisement to the information, a receiving terminal of a user receives and records the information. By contrast, in the case where the information distributor such as the broadcasting station, etc. distributes the information with the charge, generally the information attached with no advertisement is distributed to the receiving terminal of the user.
[Patent document 1] Japanese Patent Application Laid-Open Publication No.2002-44637.

In the prior art, however, in the case where the information distributor such as the broadcasting station, etc. distributes the information attached with no advertisement but with the charge, even when the user wishes to see, even if the advertisement is attached, this advertisement, the user is unable to receive the information thereof free of charge and to record the information.

Further, the information distributor such as the broadcasting station, etc. has hitherto distributed the information free of charge by attaching the advertisement to the information, however, there recently increases a case in which the information distributor such as the broadcasting station, etc. distributes a content of the distribution with a charge.

Moreover, in the case of adding the advertisement information to the information, only the information distributor such as the broadcasting station, etc. can select contents of the advertisements to be distributed. As a result, the majority of people watch the same advertisements and are imposed to watch unnecessary advertisements, wherein the advertisements can not be differentiated minutely according to age groups, their favorites, etc.

Further, generally, the information distributor such as the broadcasting station, etc. adopts any one of the case of distributing one piece of information as the free-of-charge information with the advertisement information, and the case of distributing the information as chargeable information with no advertisement information. The information distributor does not take such a changeover that the free-of-charge information with the advertisement information is distributed as chargeable information with no advertisement information.

As a result, there are the users who want to record the information distributed free of charge even with the advertisement attached and users who do not care for being charged but want to get the advertisement information removed, and nevertheless the information distributor such as the broadcasting station, etc. does not provide intricate services of performing both types of information distributions in order to meet those demands, and of changing the distribution of the chargeable information into the distribution of the free-of-charge information. Hence, there was a case of being unable to meet the desires of the users.

### SUMMARY OF THE INVENTION

It is an object of the invention to an information recording device, an advertisement information management device, an information recording method, an advertisement information management method, an information recording program, an advertisement information management program and an advertisement information management system capable of recording information inserted with advertisement information in the case of recording the information and enabling a user to acquire a benefit.

An information recording device for recording received information, comprising record executing unit inserting advertisement information into the information in accordance with a piece of instruction information indicating whether the advertisement information is inserted into the information or not, and recording the information on recording unit.

Further, the information recording device further comprises instruction information generating unit generating the instruction information.

Moreover, the information recording device further comprises notifying unit notifying an advertisement information management device for managing a user that the advertisement information has been inserted into the information and recorded on said recording unit.

Still further, an advertisement information management device comprises receiving unit receiving, from an information recording device used by a user, a notification showing that advertisement information has been inserted into information stored on said information recording device and thus recorded; and advertisement information management unit updating data about the advertisement information on the basis of a content of the notification.

Yet further, the advertisement information management device further comprises instruction information generating unit generating instruction information indicating whether or not the advertisement information is inserted into the information, and instruction information transmitting unit transmitting the instruction information to said information recording device used by the user.

Furthermore, an information recording method of recording received information comprises inserting advertisement information into the information in accordance with a piece of instruction information indicating whether the advertisement information is inserted into the information or not, and recording the information on a recording unit.

Still Furthermore, the information recording method further comprises generating the instruction information.

Yet Furthermore, the information recording method further comprises notifying an advertisement information management device for managing a user that the advertisement information has been inserted into the information and recorded on said recording unit.

Moreover, an advertisement information management method comprises, receiving, from an information recording device used by a user, a notification showing that advertisement information has been inserted into information stored on said information recording device and thus recorded, and updating data about the advertisement information on the basis of a content of the notification.

Yet moreover, the advertisement information management method further comprises generating instruction information indicating whether or not the advertisement information is inserted into the information, and transmitting the instruction information to said information recording device used by the user.

Still moreover, an information recording program-makes a computer for recording received information, function as, record executing unit inserting advertisement information into the information in accordance with a piece of instruction information indicating whether the advertisement information is inserted into the information or not, and for recording the information on recording unit.

Additionally, the information recording program makes the computer function as instruction information generating unit generating the instruction information.

Yet additionally, the information recording program makes the computer function as notifying unit notifying an advertisement information management device for managing a user that the advertisement information has been inserted into the information and recorded on said recording unit.

Still additionally, an advertisement information management program makes a computer function as receiving unit receiving, from an information recording device used by a user, a notification showing that advertisement information has been inserted into information stored on said information recording device and thus recorded, and advertisement information management unit updating data about the advertisement information on the basis of a content of the notification.

Further, the advertisement information management program makes the computer function as instruction information generating unit generating instruction information indicating whether or not the advertisement information is inserted into the information; and instruction information transmitting unit transmitting the instruction information to said information recording device used by the user.

Still further, an advertisement information management system comprises: an information recording device including record executing unit inserting advertisement information into information and thus recording the information on recording unit recording the information in accordance with instruction information indicating whether or not the advertisement information is inserted into the information; and notifying unit notifying an advertisement information management device for managing a user that the advertisement information has been inserted into the information and thus recorded on said recording unit; and an advertisement information management device including, receiving unit receiving the notification, and advertisement information management unit updating data bout the advertisement information on the basis of a content of the notification.

Yet further, in the advertisement information management system the information recording device further includes instruction information generating unit generating the instruction information.

Still further, in the advertisement information management system, the advertisement information management device further includes instruction information generating unit generating the instruction information.

One example of the operation of the invention will be explained. In the invention, for instance, the advertisement insertion terminal of the user receives an arbitrary piece of advertisement information from an advertisement agent establishing a contract, and records the information by inserting the advertisement information into the information distributed with a charge. Herein, for instance, a broadcasting station may be exemplified as the information distributor, however, the invention is not limited to the broadcasting station as the information distributor.

The advertisement insertion terminal inserts the advertisement information into the received information, thereby imposing the advertiser to pay a charge for, e.g., a chargeable broadcast to the information distributor such as the broadcasting, etc. Then, the user is able to record the information of the chargeable broadcast as a piece of free-of-charge information or as information with a benefit.

Thus, a service for inserting the advertisement information into the information and having these pieces of information recorded, will hereinafter be called a picture/sound recording instruction service. Note that in the case of recording the information, image information involves a picture recording process, and sound information involves a sound recording process. Further, in the following discussion, the record of the information might simply be referred to as picture recording of the information, however, in a case where the information contains sound information and the image information as well, simply the picture recording process might contain a sound recording process without any definite description.

In the invention, an advertisement insertion server of a picture/sound recording instruction service provider such as the advertisement agent, etc. transmits (1) the advertisement information provided by the picture/sound recording instruction service provider such as the advertisement agent, etc., wherein the advertisement information containing multimedia information such as an advertisement moving picture, an advertisement still picture, an advertisement voice, advertisement characters and an advertisement link or an arbitrary combinations thereof and (2) the picture/sound recording instruction information indicating the advertisement information being inserted into the information to the advertisement insertion terminal of the user. The advertisement information is associated with the picture/sound recording instruction information in a fixed case.

Herein, the process of associating the advertisement information with the picture/sound recording instruction information implies, for instance, that the advertisement information is linked to the picture/sound recording instruction information. Accordingly, the advertisement information being linked to the picture/sound recording instruction information, the advertisement information and the picture/sound recording instruction information may be transmitted together or may be transmitted separately to the advertisement insertion terminal from the advertisement insertion server.

Note that there is also a case where the advertisement insertion terminal may generate the picture/sound recording instruction information as well as being a case where the advertisement insertion server generates and transmits the picture/sound recording instruction information to the advertisement insertion terminal. In this case, it is unnecessary to transmit the picture/sound recording instruction information to the advertisement insertion terminal from the advertisement insertion server.

On the user's advertisement insertion terminal, on the occasion of recording the information which has been broadcast with a charge such as a TV program, etc., (3) the advertisement information is inserted into the program information on the basis of the picture/sound recording instruction information when performing the picture/sound recording of the program information.

Hereat, on the occasion of inserting the advertisement information into the information, the advertisement information may be inserted into the head of the information, or the advertisement information may also be inserted into the information in accordance with a piece of information for inserting the advertisement information, this piece of information being contained in the picture/sound recording instruction information.

It is to be noted that the benefit given to the user in the invention can be exemplified such as money, a variety of points, a premium, provision of a service and arbitrary combinations thereof by way of one example. Further, the device for managing the benefits pertaining the users can be exemplified such as the advertisement insertion server. Moreover, the terminal utilized by the user can be exemplified such as the advertisement insertion terminal.

According to the invention, the user can receive the advertisement information showing an advertisement having a content prepared independently by the picture/sound recording instruction service provider, and can insert the advertisement information into the picture/sound recording program information, whereby the picture/sound recording instruction service provider can gain a revenue from the advertiser.

The user, who establishes a contact with the picture/sound recording instruction service provider, receives the advertisement information and records the information by inserting the advertisement information into the information distributed as a chargeable broadcast. The user inserts the advertisement information into the information, thus imposes the advertiser to pay a charge for the chargeable information to the information distributor such as the broadcasting station, etc., and can record the information as the free-of-charge information or as the information with the benefit.

Further, the user can select the advertiser suited to a user's own merit by selecting the picture/sound recording instruction service provider. Moreover, the advertiser, the advertiser's own advertisement being surely watched by the users, can increase the effectiveness of advertising, and further gains a support of purchase of the commercial article through the advertisement. The chargeable information distributor has no necessity of providing the service for distributing the chargeable information free of charge as the user desires, thereby eliminating the necessity for the complicated processes.

### BRIEF DESCRIPTION OF THE DRAWINGS

FIG. 1 is a conceptual view of a system utilizing one embodiment of an advertisement insertion terminal according to the invention;

FIG. 2 is a view of an outline of architecture of the system utilizing one embodiment of the advertisement insertion terminal according to the invention;

FIG. 3 is a view of the architecture of the system utilizing one embodiment of the advertisement insertion terminal according to the invention;

FIG. 4 is a flowchart of an operation of an advertisement insertion server 309 shown in FIG. 3;

FIG. 5A is a schematic chart showing one example of a program table displayed to a user when an advertisement insertion terminal of the user accesses the advertisement insertion server the system utilizing one embodiment of the advertisement insertion terminal according to the invention;

FIG. 5B is a schematic chart showing one example of a program table displayed to a user when an advertisement insertion terminal of the user accesses the advertisement insertion server the system utilizing one embodiment of the advertisement insertion terminal according to the invention;

FIG. 6A is a conceptual chart of an advertisement information management table recorded on an advertisement information management unit 313 in the system utilizing one embodiment of the advertisement insertion terminal according to the invention;

FIG. 6B is a conceptual chart of customer company demand destination information indicating a demand destination of a customer company as a bidding advertiser identified by a piece of bidding advertiser identifying information in the advertisement information management table in the system utilizing one embodiment of the advertisement insertion terminal according to the invention;

FIG. 7A is a conceptual chart showing a structure of picture/sound recording instruction information created by a picture/sound recording instruction information generating/transmitting unit 317 the system utilizing one embodiment of the advertisement insertion terminal according to the invention;

FIG. 7B is a conceptual chart showing a structure of picture/sound recording instruction information created by a picture/sound recording instruction information generating/transmitting unit 317 the system utilizing one embodiment of the advertisement insertion terminal according to the invention;

FIG. 8 is a flowchart of an operation of an advertisement insertion terminal 308 shown in FIG. 3;

FIG. 9 is a conceptual diagram of information recorded on a program picture/sound recording terminal 307 by a picture/sound recording instruction executing unit 312 shown in FIG. 3;

FIG. 10 is a flowchart of an operation of an advertisement insertion server 309 shown in FIG. 3;

FIG. 11 is a conceptual chart of contract audience information recorded by an accounting management unit 314 shown in FIG. 3.

### DETAILED DESCRIPTION OF THE PREFERRED EMBODIMENTS

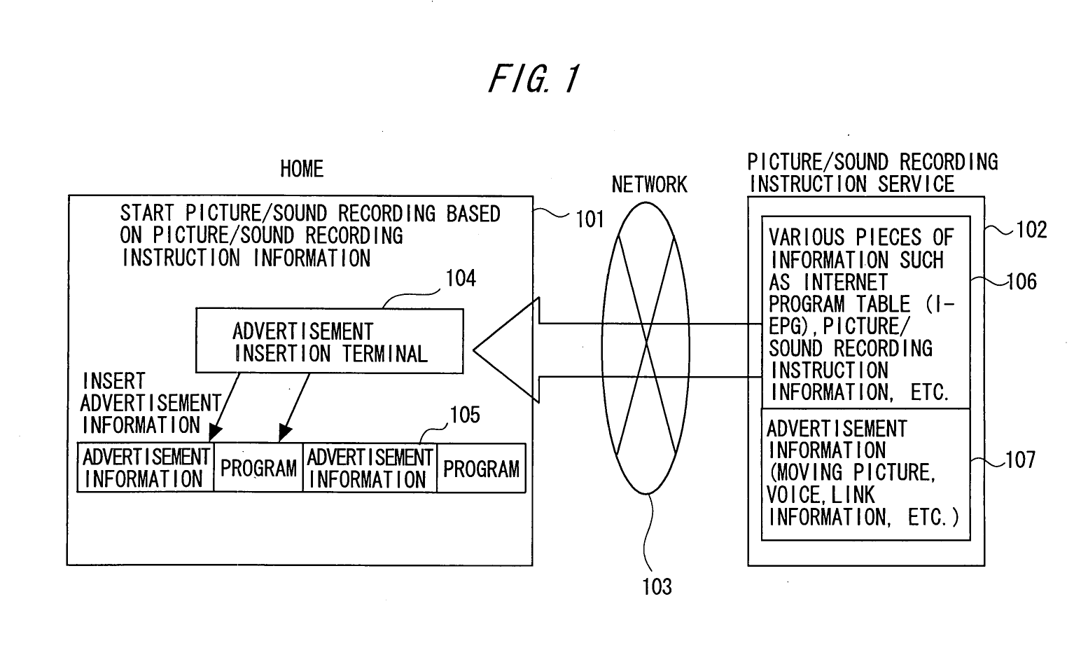

A best mode for carrying out the invention will hereinafter be described with reference to the drawings. A configuration of an embodiment, which follows, is an exemplification, and the invention is not limited to the configuration of the embodiment. To begin with, a concept of a system utilizing one embodiment of an advertisement insertion terminal serving as an information recording device according to the invention (which will hereinafter be simply referred to as an advertisement insertion terminal), will be explained referring to FIG. 1. FIG. 1 is a conceptual view of the system utilizing one embodiment of the advertisement insertion terminal according to the invention.

As shown in FIG. 1, the system includes homes 101 exchanging pieces of information with each other via a network 103, and a picture/sound recording instruction service 102. The home 101 is equipped with an advertisement insertion terminal 104. This advertisement insertion terminal 104 inserts advertisement information into an interval of a program in accordance with an instruction given from the picture/sound recording instruction service 102, thereby assembling information 105 to be recorded.

The picture/sound recording instruction service 102 transmits various categories of information 106 such as an Internet program table (I-EPG), picture/sound recording instructing information, etc., and advertisement information 107 to the advertisement insertion terminal 104 in the home 101.

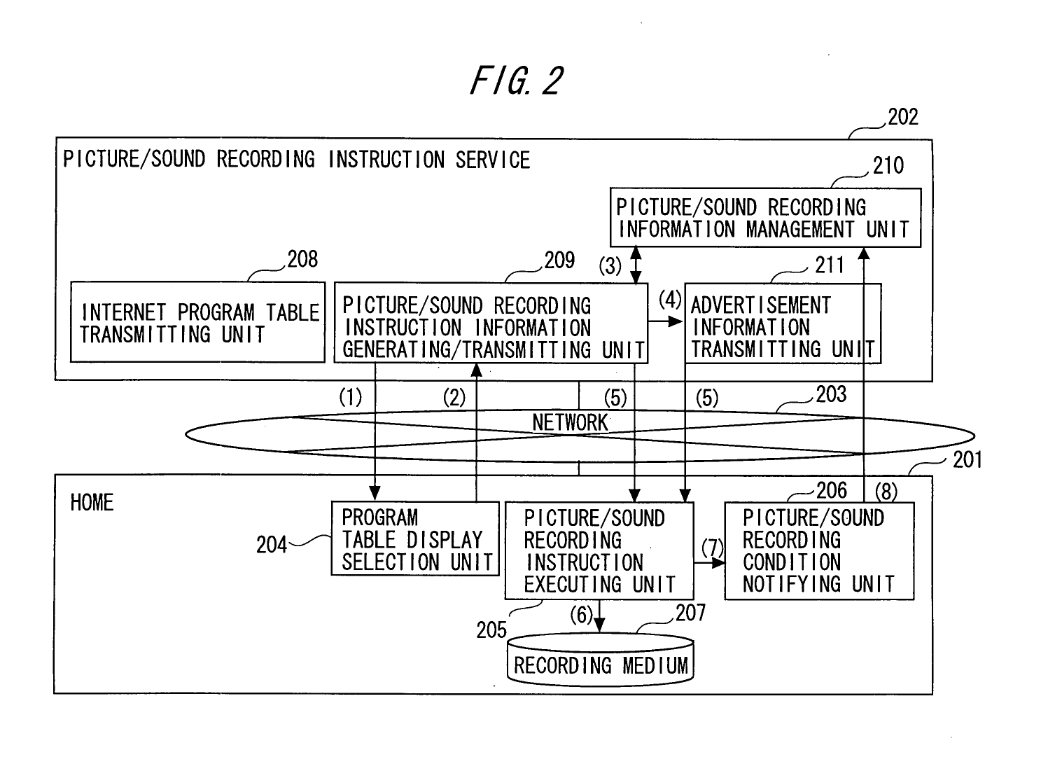

Note that the adverting information 107, which is not particularly limited in the invention, can involve using arbitrary combinations of advertisement moving picture, advertisement still picture, advertisement characters, URLs (Uniform Resource Locators) of advertisement links, etc. Next, an outline of architecture of the system utilizing one embodiment of the advertisement insertion terminal according to the invention, will be described with reference to FIG. 2. FIG. 2 is a diagram of the outline of the architecture of the system utilizing one embodiment of the advertisement insertion terminal according to the invention.

In the system illustrated in FIG. 2, a home 201 and a picture/sound recording instruction service 202 are connected to each other via a network 203. The home 201 is equipped with a program table display selection unit 204, a picture/sound recording instruction executing unit 205, a picture/sound recording condition notifying unit 206 and a recording medium 207.

Further, the picture/sound recording instruction service 202 includes an Internet program table transmitting unit 208, a picture/sound recording instruction information generating/transmitting unit 209, a picture/sound recording information management unit 210 and an advertisement information transmitting unit 211. An operation of the system shown in FIG. 2 will hereinafter be explained.

To start with, the Internet program table transmitting unit 208 transmits a program table (broadcasting time and a program list) to the program table display selection unit 204 (1). Next, the program table display selection unit 204 transmits the program information selected by the user to the picture/sound recording instruction information generating/transmitting unit 209 (2).

Next, the picture/sound recording instruction information generating/transmitting unit 209 queries the picture/sound recording information management unit 210 about pieces of information showing whether the picture recording is possible or not, charging is possible or not, the insertion of the advertisement is possible or not, a discount is possible or not, a preferential treatment is possible or not, and so on (3).

Subsequently, the picture/sound recording instruction information generating/transmitting unit 209 instructs the advertisement information transmitting unit 211 to transmit the advertisement information in the case of sending the advertisement information in accordance with a result of the query in the process (3) (5).

Further, the picture/sound recording instruction information generating/transmitting unit 209 transmits a piece of picture/sound recording instruction information to the picture/sound recording instruction executing unit 205 (5). The picture/sound recording instruction information contains information for inserting the advertisement information into the information.

Next, the picture/sound recording instruction executing unit 205 executes a process of recording the picture and sound on the recording medium 207 in a way that inserts the received advertisement information into the information such as a program, etc. (6). Subsequently, the picture/sound recording condition notifying unit 206 detects an end of the normal picture/sound recording (7).

Next, the picture/sound recording condition notifying unit 206 having detected the end of the normal picture/sound recording, notifies the picture/sound recording information management unit 210 of the end of the picture/sound recording (8). Hereat, the picture/sound recording instruction information generating/transmitting unit 209 may also be installed in the home 201.

Further, the picture/sound recording condition notifying unit 206, in the case of notifying the picture/sound recording information management unit 210 of the end of the picture/sound recording, may send the notification each time the picture/sound recording of one piece of information is ended, and may also send a set of notifications to the picture/sound recording information management unit 210 at a predetermined timing by storing a plurality of notifications for a fixed period of time. Moreover, the picture/sound recording information management unit 210 serves as an advertisement information management unit and an accounting management unit.

Herein, the advertisement information management unit retains pieces of information showing who places an advertisement in a program, which program receives an insertion of the advertisement, which and how much advertisement is placed and charged, and also information showing how much the advertisement has actually been utilized. Further, the accounting management unit records accounting information on the information of the program recorded in home, and information about benefits of the information of the advertisement inserted into the program.

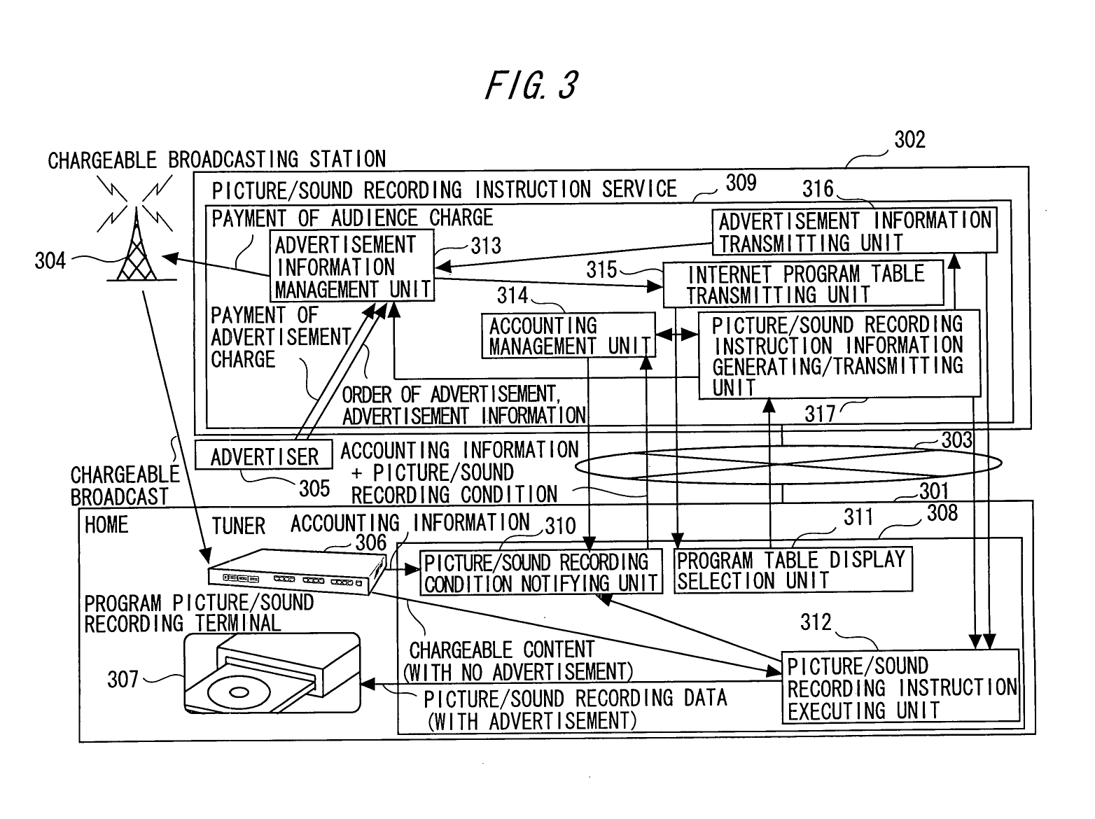

Next, a specific example of the architecture of the system utilizing the embodiment of the advertisement insertion terminal according to the invention, will be explained with reference to FIG. 3. FIG. 3 is a view of the architecture of the system utilizing the embodiment of the advertisement insertion terminal according to the invention.

In the system shown in FIG. 3, a home 301 and a picture/sound recording instruction service 302 are connected to each other via a network 303. This network 303 can be exemplified such as the Internet. Further, this network 303 can involve the use of a CATV network, telephone lines, etc.

Moreover, a chargeable broadcasting station 304 broadcasts a chargeable broadcast as the information according to the invention to a tuner 306 in the home 303. Further, an advertiser 305 sends a payment of an advertisement charge, an order of the advertisement and the advertisement information to the advertisement information management unit 313 of the advertisement insertion server 302.

The home 301 is equipped with the tuner 306, the program picture/sound recording terminal 307 for recording the information on a hard disk and a video tape, and an advertisement insertion terminal 308. The recording medium used by the program picture/sound recording terminal 307 is not limited to anything particular.

The advertisement insertion terminal 308 includes a picture/sound recording condition notifying unit 310 for receiving a piece of accounting information on the chargeable broadcast from the tuner 306 and sending the accounting information and a picture/sound recording condition to an accounting management unit 314 on the basis of the information given from a picture/sound recording instruction executing unit 312; a program table display selection unit 311, and the picture/sound recording instruction executing unit 312. Further, the picture/sound recording instruction service 302 includes an advertisement insertion server 309.

The advertisement insertion server 309 includes, an advertisement information management unit 313 for selecting an advertisement to be inserted into a specified program or an unspecified category of program by, e.g., a bid, an accounting management unit 314, an Internet program table transmitting unit 315; an advertisement information transmitting unit 316 for transmitting the advertisement information selected by the advertisement information management unit 313 to the picture/sound recording instruction executing unit 312 of the advertisement insertion terminal 308, and a picture/sound recording instruction information generating/transmitting unit 317.

Note that the function of the picture/sound recording instruction information generating/transmitting unit 317 can be provided on the side of the home 301. In this case, the picture/sound recording instruction information generating/transmitting unit 317 of the advertisement insertion server 309 is not required. For example, the advertisement insertion terminal 308 may be provided with the function of the picture/sound recording instruction information generating/transmitting unit 317.

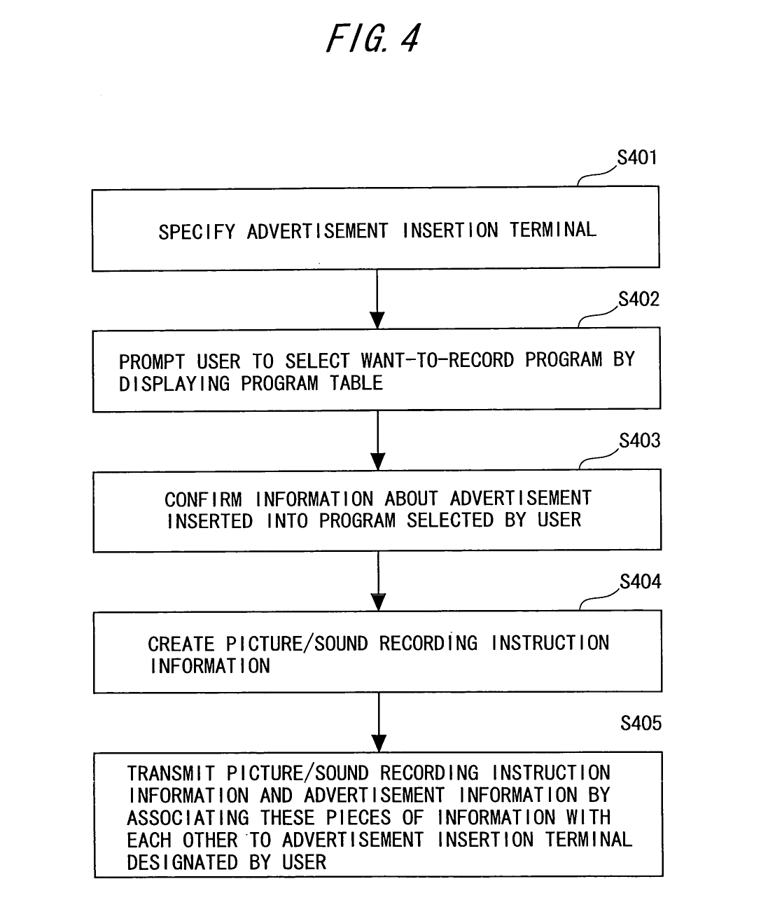

Next, an operation of the system shown in FIG. 3 will be explained. At first, FIG. 4 shows a flowchart of an operation of the advertisement insertion server 309 illustrated in FIG. 3. To start with, the Internet program table transmitting unit 315 specifies the advertisement insertion terminal that accesses the advertisement insertion server 309 (S401).

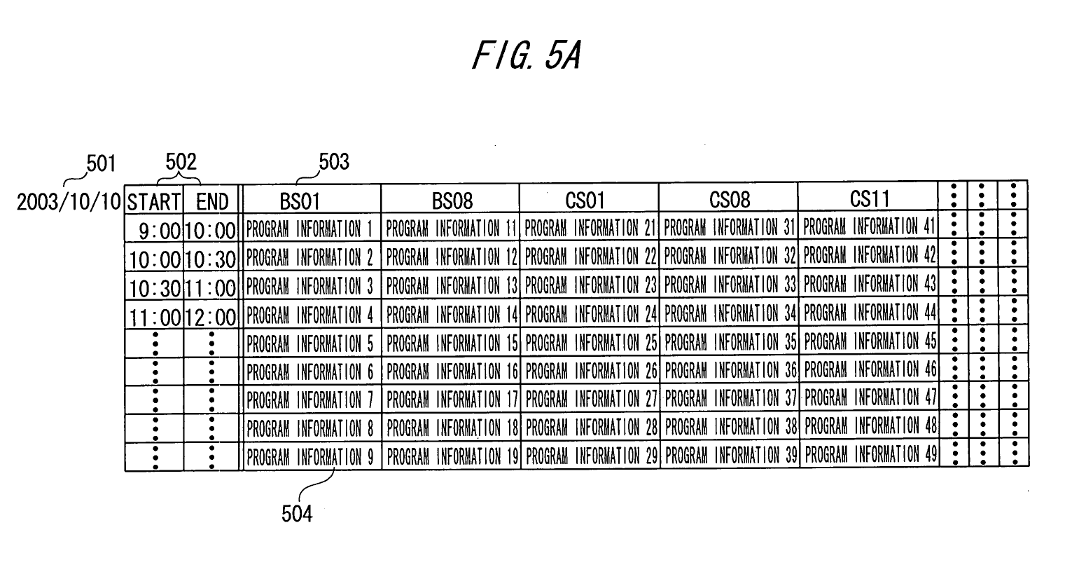

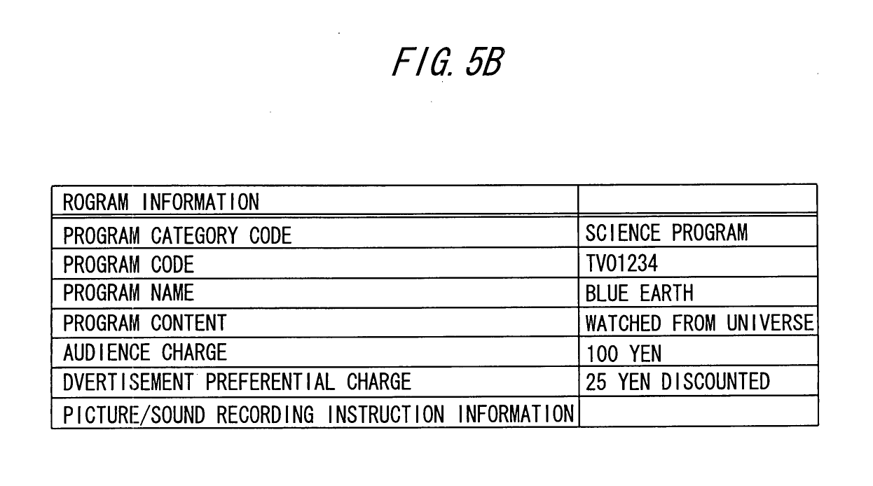

Subsequently, the Internet program table transmitting unit 315 sends a program table to the advertisement insertion terminal of a user, and prompts the user to select a want-to-record program by displaying the program table to the user (S402). Herein, the program table displayed to the user will be explained referring to FIG. 5A and FIG. 5B. FIG. 5A and FIG. 5B is a schematic chart showing one example of the program table displayed to the user when the advertisement insertion terminal of the user accesses the advertisement insertion server in the system utilizing one embodiment of the advertisement insertion terminal according to the invention.

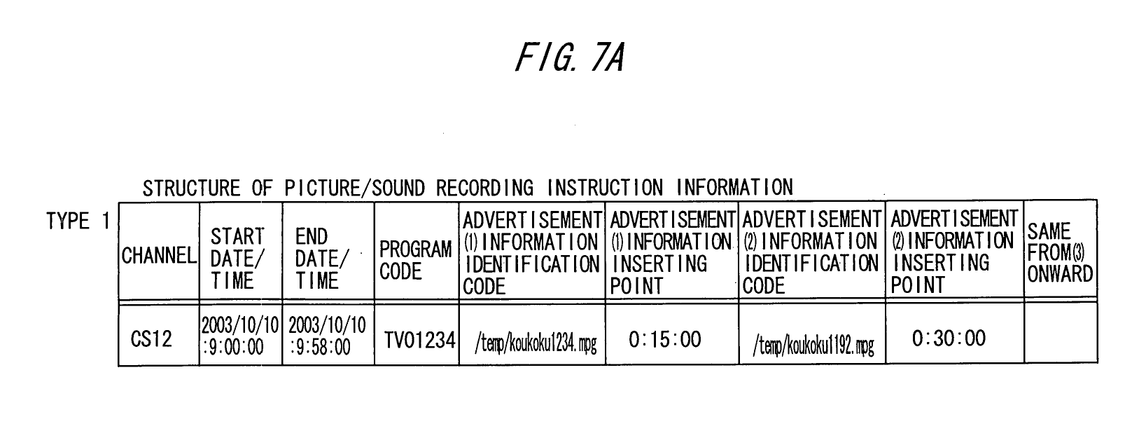

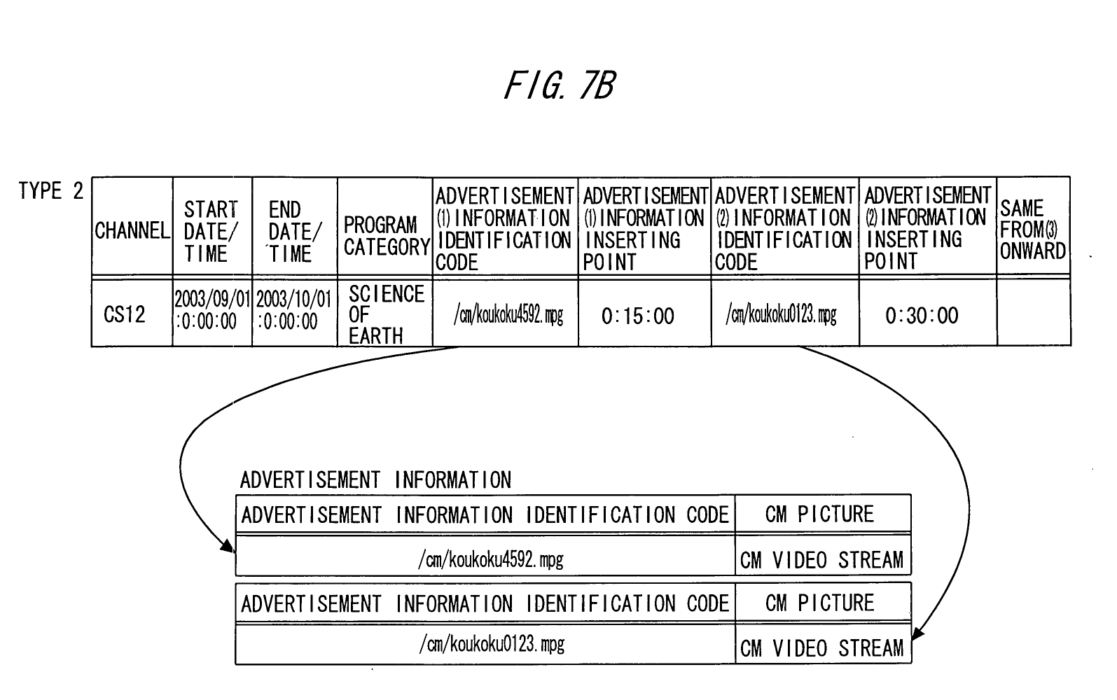

As shown in FIG. 5A, a date 501, start/end time 502, a channel 503 and program information 504 are indicated in the program table displayed to the user. Then, as shown in FIG. 5B, the program information 504 contains pieces of information such as a program category code, a program code, a program name, a program content, an audience charge, an advertisement preferential charge and picture/sound recording instruction information, whereby the user can confirm the information. Note that the information about the picture/sound recording instruction information is shown in, e.g., FIG. 7 which will be given later on.

Next, in S402 shown in FIG. 4, when the user selects a program to be recorded, the program table display selection unit 311 sends the information about the program selected by the user to the picture/sound recording instruction information generating/transmitting unit 317.

Subsequently, the picture/sound recording instruction information generating/transmitting unit 317 confirms pieces of information about the advertisement inserted into the program selected by the user on the basis of the advertisement information management table recorded in the advertisement information management unit 313 (S403).

Herein, the pieces of information about the advertisement inserted into the program selected by the user, which is confirmed by the picture/sound recording instruction information generating/transmitting unit 317, are, for example, a content of the advertisement, time when inserting the advertisement into the program, and so on.

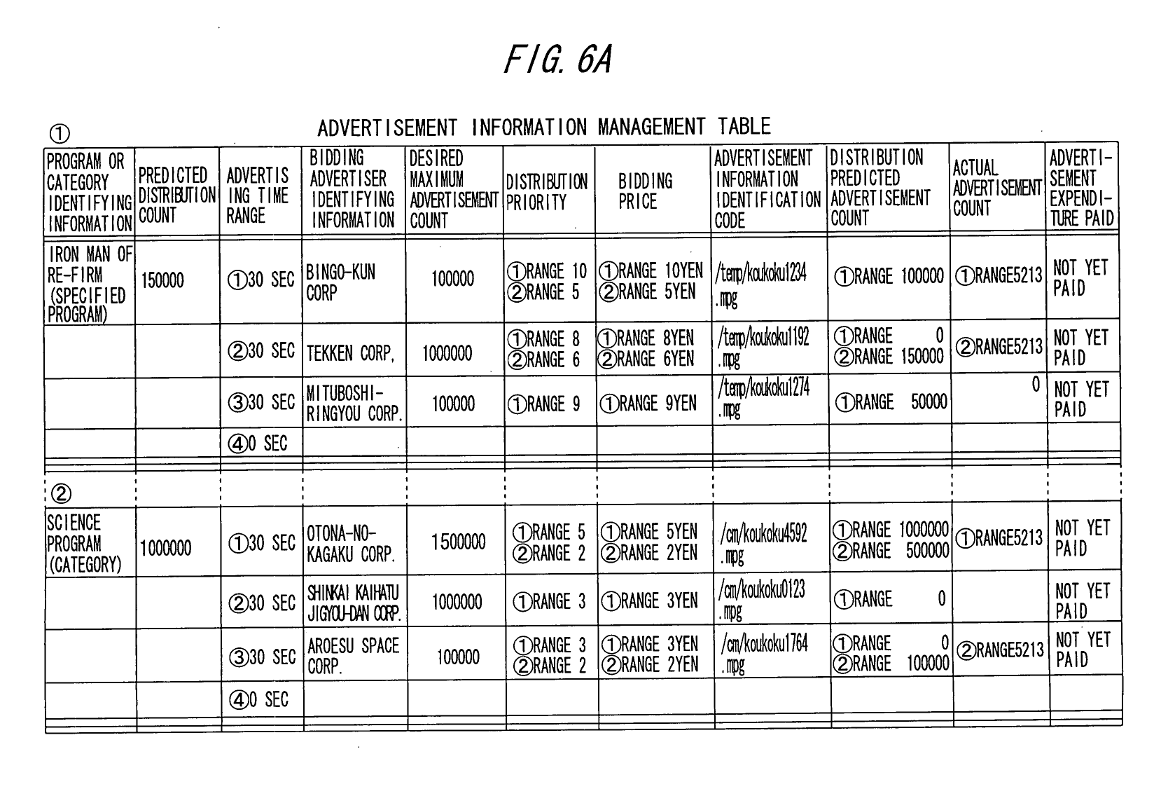

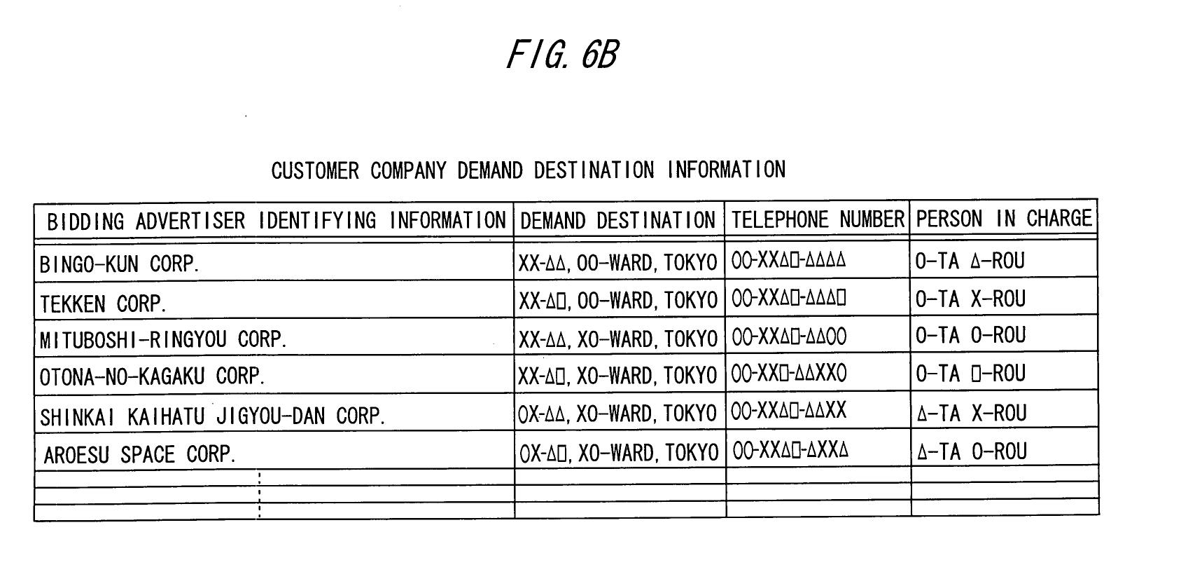

Herein, an advertisement information management table recorded in the advertisement information management unit 313, will be explained with reference to FIG. 6A and FIG. 6B. FIG. 6A and FIG. 6B is a conceptual chart of the advertisement information management table recorded in the advertisement information management unit 313 in the system utilizing one embodiment of the advertisement insertion terminal according to the invention.

FIG. 6A is the conceptual chart of the advertisement information management table recorded in the advertisement information management unit 313. FIG. 6B is a conceptual chart of customer company demand destination information indicating a demand destination of a customer company as a bidding advertiser identified by a piece of bidding advertiser identifying information in the advertisement information management table.

The advertisement information management table contains, as items, program or category identifying information, a predicted distribution count, an advertisement time range, bidding advertiser identifying information, a desired maximum advertisement count, a distribution priority, a bidding price, an advertisement information identification code, a distribution predicted advertisement count, an actual advertisement count and an advertisement expenditure paid.

The program or category identifying information indicates a program name or a category of the program. The predicted distribution count indicates a predicted value of the number of the advertisement insertion terminals to which the program information is distributed. The advertisement time range shows a plurality of different time ranges in the program into which the advertisement is inserted.

The bidding advertiser identifying information indicates the information of the advertiser desiring for the insertion of the advertisement into the program. The desired maximum advertisement count indicates the number of the advertisement insertion terminals in which the information of the advertisement desired by each advertiser is recorded. The distribution priority indicates a predetermined range of priority for every advertiser. This priority is generally coincident with a value of the bidding price, however, there might be a case of being uncoincident with the bidding price, taking elements other than the bidding price into consideration.

The bidding price indicates a monetary price as a befit given to the user in a case where each advertiser inserts the advertisement information into a predetermined time range and the user records the advertisement information on the advertisement insertion terminal. Note that the benefit given to the user is not limited to the money and may be various types of points according to the invention.

The advertisement information identification code indicates an identification code of the advertisement information inserted by the individual advertiser into the program. The distribution predicted advertisement count indicates the number of the advertisement insertion terminals of the users, to which the advertisement information of every advertiser is distributed, which is determined based on the predicted distribution count, the desired maximum advertisement count and the distribution priority. The actual advertisement count indicates the number of the advertisement insertion terminals to which the advertisement is distributed at the present.

The advertisement expenditure paid indicates whether or not each advertiser has paid an advertisement expenditure to a company providing the picture/sound recording service of the invention. On the other hand, the customer company demand destination information shown in FIG. 6B contains, as items, bidding advertiser identifying information, a demand destination, a telephone number and a person in charge.

Next, the discussion gets back to the explanation of the flowchart in FIG. 4. The picture/sound recording instruction information generating/transmitting unit 317 creates, based on the confirmed advertisement information, the picture/sound recording instruction information (S404). Herein, the picture/sound recording instruction information created by the picture/sound recording instruction information generating/transmitting unit 317, will be explained with reference to FIG. 7A and FIG. 7B.

FIG. 7A and FIG. 7B is a conceptual chart showing a structure of the picture/sound recording instruction information created by the picture/sound recording instruction information generating/transmitting unit 317 in the system utilizing one embodiment of the advertisement insertion terminal according to the invention.

In the example shown in FIG. 7A and FIG. 7B, there are exemplified two cases where piece of picture/sound recording instruction information are given as the picture/sound recording instruction information of a type 1(FIG. 7A) in the case of inserting a CM (Commercial Message: an advertisement) in a way that specifies a program, and given as the picture/sound recording instruction information of a type 2(FIG. 7B) in the case of inserting the CM (Commercial Message) in a way that specifies a channel and a category of the program.

As shown in FIG. 7, both of the type 1 and the type 2 have items such as a channel, start date/time, end date/time, an advertisement (1) information identification code, an advertisement (1) information inserting position, an advertisement (2) information identification code, an advertisement (2) information inserting position, and, the same from (3) onward.

Further, the type 1 contains a program code as an item. Further, the type 2 contains a program category as an item. Moreover, in the type 2, for instance, a CM video stream corresponding to “/cm/koukoku4592.mpg” in the advertisement (1) information identification code is set as the advertisement information, and, for example, a CM video stream corresponding to “/cm/koukoku0123.mpg” in the advertisement (2) information identification code is set as the advertisement information.

Next, the discussion gets back to the explanation of the flowchart in FIG. 4. The picture/sound recording instruction information generating/transmitting unit 317 and the advertisement information transmitting unit 316 transmits, to the picture/sound recording instruction executing unit 312 of the advertisement insertion terminal designated by the user, the picture/sound recording instruction information and the advertisement information in a way that associates these pieces of information with each other (S405). Herein, the process of associating the picture/sound recording instruction information and the advertisement information with each other involves, it can be considered, assigning an advertisement information identification code transmitted by the advertisement information transmitting unit 316 to the picture/sound recording instruction information.

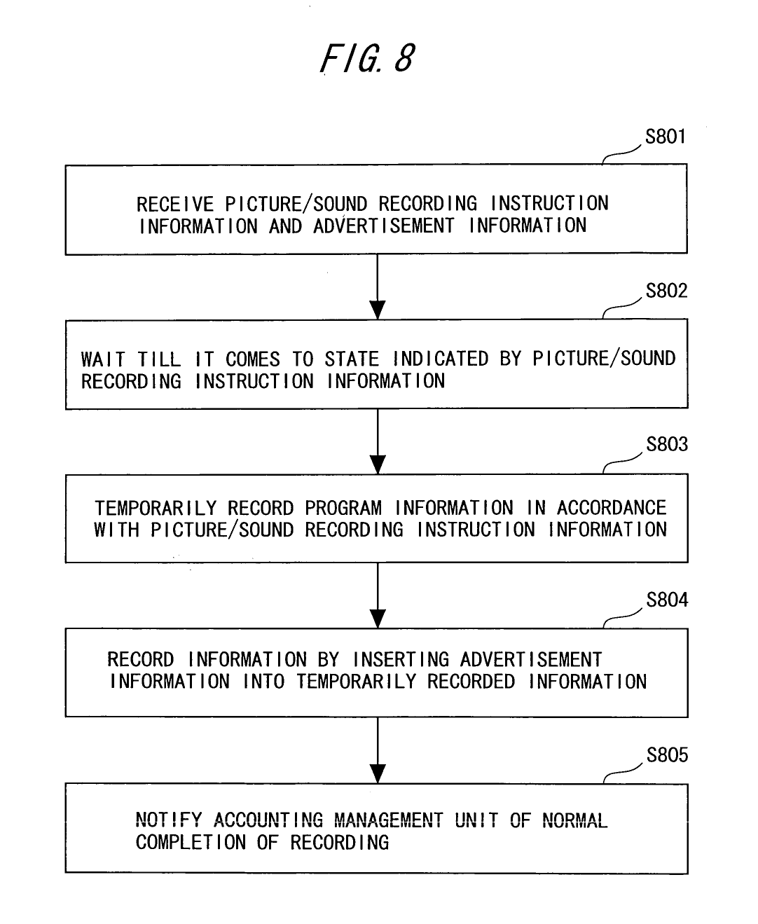

Next, an operation of the advertisement insertion terminal 308 shown in FIG. 3 will be explained with reference to FIG. 8. FIG. 8 is a flowchart of the operation of the advertisement insertion terminal 308 illustrated in FIG. 3. As shown in FIG. 8, at first, in S801, the picture/sound recording instruction executing unit 312 receives the picture/sound recording instruction information sent from the picture/sound recording instruction information generating/transmitting unit 317 and the advertisement information sent from the advertisement information transmitting unit 316.

Subsequently, the picture/sound recording instruction executing unit 312 waits till it comes to a state indicated by the picture/sound recording instruction information (S802). What can be given as this state indicated by the picture/sound recording instruction information is, for example, predetermined time after the broadcast of the program selected by the user has been started.

Next, the picture/sound recording instruction executing unit 312, in the case where it comes to the state indicated by the picture/sound recording instruction information, temporarily records the program information in accordance with the picture/sound recording instruction information (S803). Herein, the temporary record of the program is done in consideration of a case where the advertisement information is inserted into the program information but can not be recorded directly on the program picture/sound recording terminal 307. If the advertisement information is inserted into the program information but can be recorded directly on the program picture/sound recording terminal 307, the temporary recording operation in S803 may be deleted.

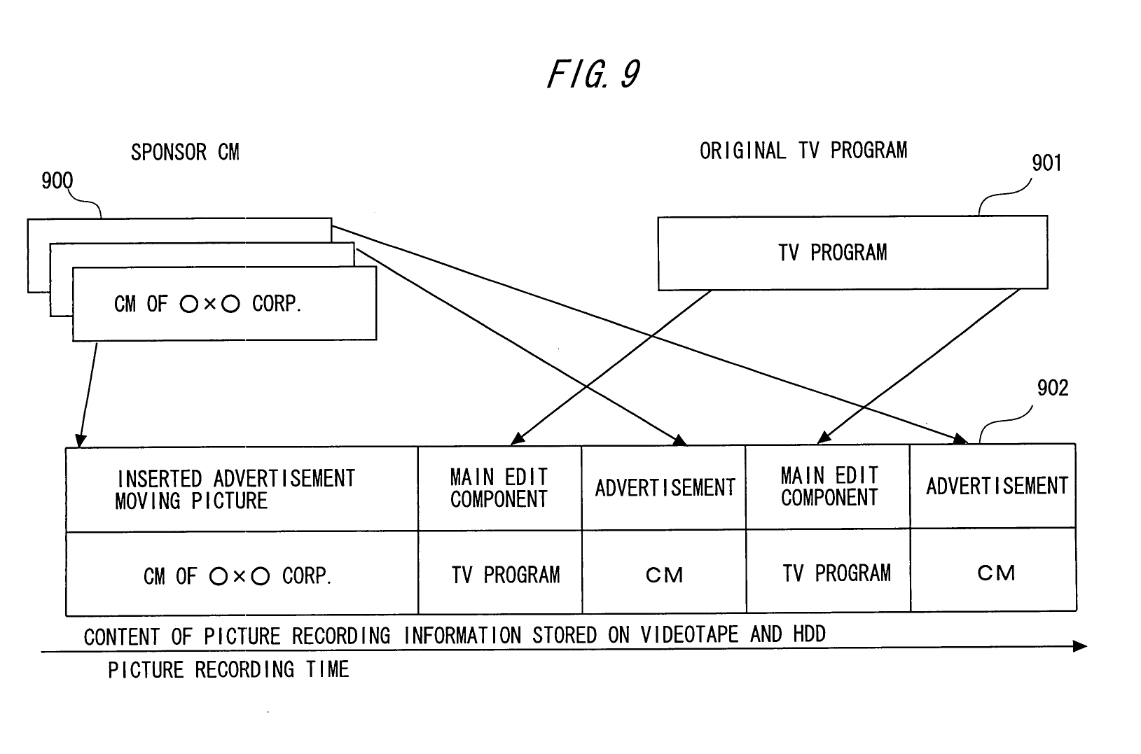

Subsequently, the picture/sound recording instruction executing unit 312 inserts the advertisement information into the temporarily recorded information and records these pieces of information on the program picture/sound recording terminal (S804). Herein, the information recorded in S804 will be explained with reference to FIG. 9. FIG. 9 is a conceptual diagram of the information recorded on the program picture/sound recording terminal 307 by the picture/sound recording instruction executing unit 312 shown in FIG. 3.

In the example shown in FIG. 9, an explanation will be given by exemplifying a case of inserting a CM of a sponsor into a TV program. As shown in FIG. 9, a CM 900 of the sponsor is inserted into an original TV program 901.

Namely, the sponsor CM 900 having a content of an x-Corporation's CM is inserted as a moving picture of the advertisement into an interval of the original TV program 901 as a main edit component. Then, information 902 gets composed of a combination of the main edit component and the advertisement.

Next, the picture/sound recording instruction executing unit 312 notifies the picture/sound recording condition notifying unit 310 of a completion of recording the program information. The picture/sound recording condition notifying unit 310 notifies the accounting management unit 314 of the normal completion of the program information as a picture/sound recording condition (S805).

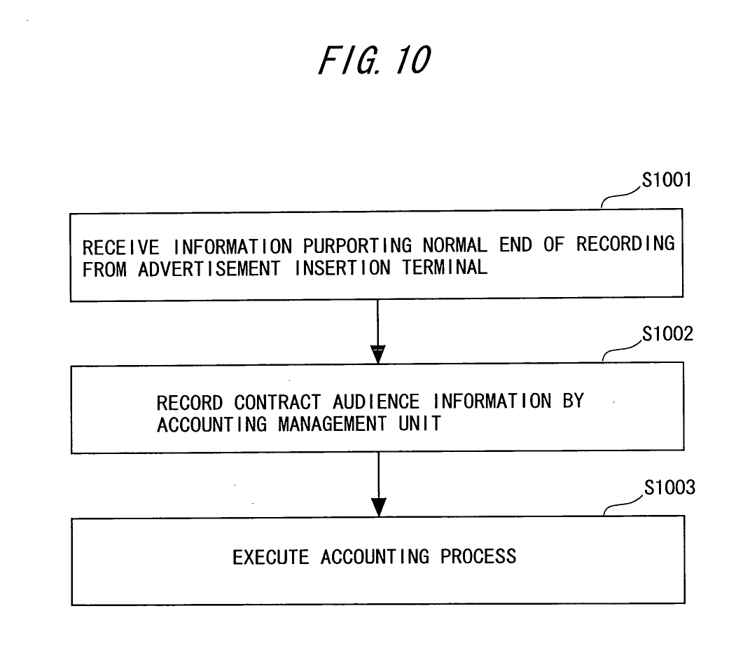

Subsequently, an operation of the advertisement insertion server shown in FIG. 3 after the normal completion of recording the program from the advertisement insertion terminal, will be described with reference to FIG. 10. FIG. 10 is a flowchart of the operation of the advertisement insertion server 309 shown in FIG. 3.

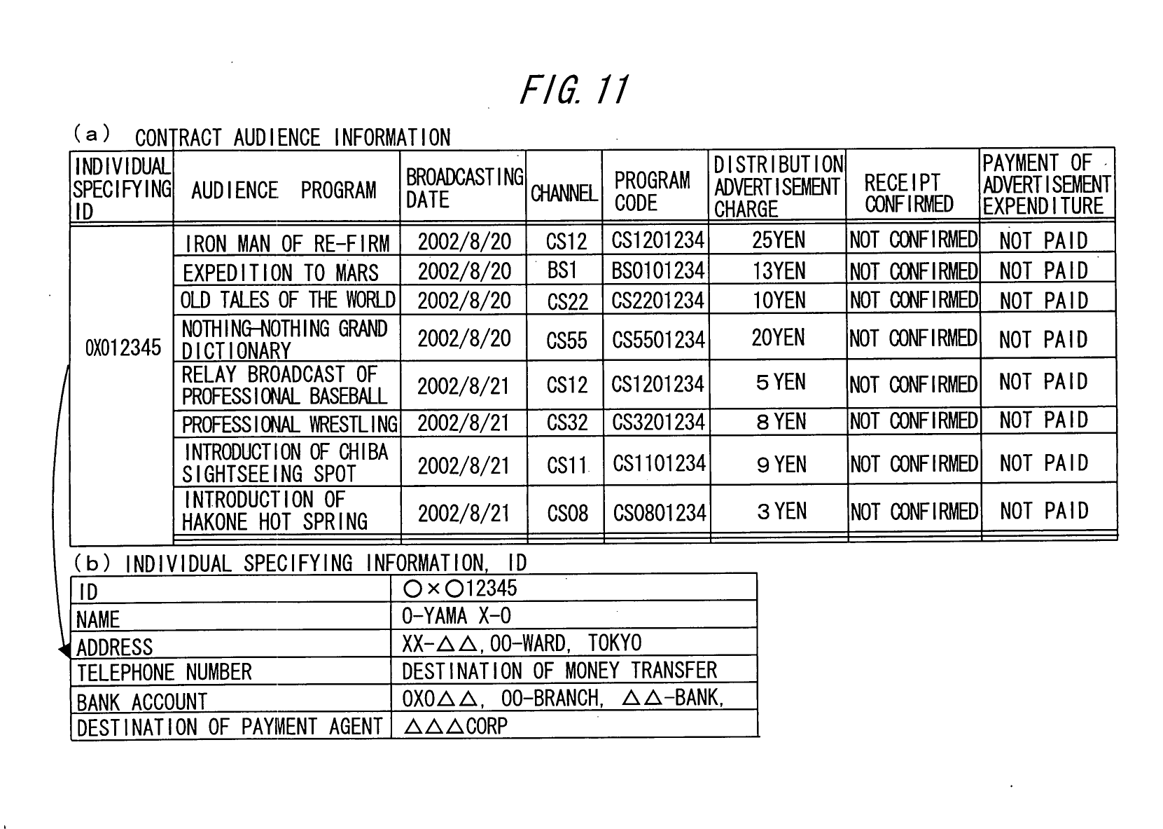

To begin with, in S1001, the accounting management unit 314 receives a piece of information purporting that the record of the program information from the advertisement insertion terminal has normally been ended. Next, the accounting management unit 314 records the same information as contract audience information (S1002). Herein, the contract audience information recorded by the accounting management unit 314 will be explained referring to FIG. 11. FIG. 11 is a conceptual chart of the contract audience information recorded by the accounting management unit 314 shown in FIG. 3.

As shown in FIG. 11(a), the contract audience information contains, as items, an individual specifying ID, an audience program, a broadcasting date, a channel, a program code, a distribution advertisement charge, a receipt confirmed and a payment of advertisement expenditure.

Herein, the distribution advertisement charge implies a benefit for inserting the advertisement. This benefit is money in FIG. 11 but is not limited to the money and may also be various types of points.

The receipt confirmed is a piece of information indicating whether or not the company performing the picture/sound recording instruction service in the embodiment has received the advertisement charge from the advertiser. The payment of advertisement expenditure is a piece of information indicating whether or not the company performing the picture/sound recording instruction service in the embodiment has paid the advertisement expenditure to the user.

Further, as shown in FIG. 11(b), individual specifying information is associated with the individual specifying ID. The individual specifying information contains, as items, an ID, a name, an address, a telephone number, a destination of money transfer and a destination of payment agent.

Next, the advertisement information management unit 313 executes an accounting process such as paying an audience charge to, e.g., the chargeable broadcasting station 304 (S1003). Note that the embodiment can involve using, for example, a setting that a predetermined advertisement insertion terminal always receives the picture/sound recording instruction service, a station-by-station setting of receiving the picture/sound recording instruction service in the case of recording the information that is broadcast from an unspecified station, and a program-by-program setting of receiving the picture/sound recording instruction service in the case of recording the information of an unspecified program.

As described above, the system utilizing one embodiment of the advertisement insertion terminal according to the invention, enables the user to acquire the benefit by inserting the advertisement information into the information such as the program, etc. which is broadcast with a charge as the user desires.

Further, the user selects a provider of the picture/sound recording instruction service for inserting the advertisement information suited to the user's interest and necessity, whereby the content of the advertisement information inserted into the program information can be made suitable for the user's own interest and necessity.

1. An information recording device for recording received information, comprising:
a record executing unit inserting advertisement information into the information in accordance with a piece of instruction information indicating whether the advertisement information is inserted into the information or not, and recording the information on recording unit.

2. An information recording device according to claim 1, further comprising an instruction information generating unit generating the instruction information.

3. An information recording device according to claim 1, further comprising a notifying unit notifying an advertisement information management device for managing a user that the advertisement information has been inserted into the information and recorded on said recording unit.

4. An advertisement information management device comprising:
a receiving unit receiving, from an information recording device used by a user, a notification showing that advertisement information has been inserted into information stored on said information recording device and thus recorded; and
an advertisement information management unit updating data about the advertisement information on the basis of a content of the notification.

5. An advertisement information management device according to claim 4, further comprising:
an instruction information generating unit generating instruction information indicating whether or not the advertisement information is inserted into the information; and
an instruction information transmitting unit transmitting the instruction information to said information recording device used by the user.

6. An information recording method of recording received information, the method comprising:
inserting advertisement information into the information in accordance with a piece of instruction information indicating whether the advertisement information is inserted into the information or not; and
recording the information on a recording unit.

7. An information recording method according to claim 6, further comprising generating the instruction information.

8. An information recording method according to claim 6, further comprising notifying an advertisement information management device for managing a user that the advertisement information has been inserted into the information and recorded on said recording unit.

9. An advertisement information management method comprising:
receiving, from an information recording device used by a user, a notification showing that advertisement information has been inserted into information stored on said information recording device and thus recorded; and
updating data about the advertisement information on the basis of a content of the notification.

10. An advertisement information management method according to claim 9, further comprising:
generating instruction information indicating whether or not the advertisement information is inserted into the information; and
transmitting the instruction information to said information recording device used by the user.

11. An information recording program for making a computer for recording received information, function as:
record executing unit inserting advertisement information into the information in accordance with a piece of instruction information indicating whether the advertisement information is inserted into the information or not, and for recording the information on recording unit.

12. An information recording program according to claim 11, wherein said computer is made to function as instruction information generating unit generating the instruction information.

13. An information recording program according to claim 11, wherein said computer is made to function as notifying unit notifying an advertisement information management device for managing a user that the advertisement information has been inserted into the information and recorded on said recording unit.

14. An advertisement information management program for making a computer function as:
receiving unit receiving, from an information recording device used by a user, a notification showing that advertisement information has been inserted into information stored on said information recording device and thus recorded; and
advertisement information management unit updating data about the advertisement information on the basis of a content of the notification.

15. An advertisement information management program according to claim 14, wherein said computer is made to function as:
instruction information generating unit generating instruction information indicating whether or not the advertisement information is inserted into the information; and
instruction information transmitting unit transmitting the instruction information to said information recording device used by the user.

16. An advertisement information management system comprising:
an information recording device including: record executing unit inserting advertisement information into information and thus recording the information on recording unit recording the information in accordance with instruction information indicating whether or not the advertisement information is inserted into the information; and notifying unit notifying an advertisement information management device for managing a user that the advertisement information has been inserted into the information and thus recorded on said recording unit; and
an advertisement information management device including: receiving unit receiving the notification; and advertisement information management unit updating data bout the advertisement information on the basis of a content of the notification.

17. An advertisement information management system according to claim 16, wherein said information recording device further includes instruction information generating unit generating the instruction information.

18. An advertisement information management system according to claim 16, wherein said advertisement information management device further includes instruction information generating unit generating the instruction information.
